(19) United States
(12) Patent Application Publication
(10) Pub. No.: US 2018/0288968 A1
(43) Pub. Date: Oct. 11, 2018

(54) WATER REGULATION SYSTEM

(71) Applicants: Joey Lee Cisco, Fyffe, AL (US); April Brigitte Cisco, Fyffe, AL (US)

(72) Inventors: Joey Lee Cisco, Fyffe, AL (US); April Brigitte Cisco, Fyffe, AL (US)

(21) Appl. No.: 15/484,798

(22) Filed: Apr. 11, 2017

(51) Int. Cl. A01K 7/02

(52) U.S. Cl. CPC A01K 7/025; A01K 7/027

(57) ABSTRACT

Apparatus, systems, and methods are provided for regulating a fluid level provided in an animal watering trough. The components that are part of the apparatus, system, and method may include a housing having at least one side wall, base, and removable cover where the housing define a cavity that is configured to contain fluid. Also, the components include a fill valve positioned within the cavity of the housing for controlling a level of the fluid within the housing, an intake port that may be connected to a fluid supply, and an output port in fluid communication with the animal watering trough. The system may be configured such that when the fill valve is in a first position, the fluid is prevented from flowing between the intake port and the housing, and when the fill valve moves into a second position, the fluid flows via the intake port into the housing.

### BACKGROUND

Prior art animal watering troughs use a type of valve that floats at the surface of the fluid in a portion of the trough from which animals drink. When the fluid level in the animal watering trough is at a level below a desired fluid level, then the valve, which is connected to a fluid supply, will open and cause fluid to fill the animal watering trough until the valve shuts off the supply of fluid. However, these types of animal watering troughs, in which the valve is accessible to the animals drinking from the animal watering trough, are problematic since the animals constantly interfere with and damage the valve. Consequentially, when the valve is damaged, this may cause a fluid line connected to the animal watering trough to continue to flow and overfill the animal watering trough, and flood a surround area of the animal watering trough. An individual will have to recognize this occurrence and shut off the fluid supply to the animal watering trough. This is also problematic because this wastes water and unnecessarily leaves property owners with exorbitant water bills. Various embodiments of the present water regulation systems and methods herein recognize and address the foregoing considerations, and others, of prior art designs and methods of use.

### SUMMARY OF THE INVENTION

In various embodiments, a water regulation system for regulating a fluid level in an animal watering trough may be provided that comprises a housing having at least one side wall, a base, and a removable cover, wherein the at least one side wall, the base, and the removeable cover define a cavity that is configured to contain fluid. Additionally, the water regulation system may include a fill valve positioned within the cavity of the housing for controlling a level of the fluid within the housing, an intake port configured to be connected to a fluid supply, and an output port in fluid communication with an animal watering trough. The system may be configured such that when the fill valve is in a first position, the fluid is prevented from flowing between the intake port and the housing, and when the fill valve moves into a second position, the fluid flows via the intake port into the housing.

Additionally, in various embodiments, another innovative aspect of the subject matter of the invention includes animal watering trough water regulation apparatus that comprises an animal watering trough that is configured to contain fluid, and a water regulation apparatus. The water regulation apparatus may comprise a housing having at least one side wall, a base, and a removable cover, wherein the at least one side wall, the base, and the removeable cover define a cavity that is configured to contain fluid. The water regulation apparatus may also include a fill valve positioned within the cavity of the housing for controlling a level of the fluid within the housing, an intake port configured to be connected to a fluid supply, and an output port operatively coupled to the animal watering trough. Further, the water regulation apparatus may be configured with the water regulation system such that when the fill valve is in a first position, the fluid is prevented from flowing between the intake port and the housing, and when the fill valve moves into the second position, the fluid flows via the intake port into the housing and from the cavity of the housing into the animal watering trough.

Further, in various embodiments, another innovative aspect of the subject matter of the invention includes a method for controlling a level of fluid in an animal watering trough by a water regulation apparatus. The method may comprise providing a water regulation apparatus that comprises a housing having: at least one side wall, a base, and a removable cover, wherein the at least one side wall, the base, and the removeable cover define a cavity that is configured to contain fluid. The water regulation apparatus also comprises a fill valve positioned within the cavity of the housing for controlling a level of the fluid within the animal watering trough, an intake port configured to be connected to a fluid supply, and an output port. The method may further comprise positioning the housing with respect to an animal watering trough in order to set a fluid level to be maintained in the animal watering trough, and coupling the output port of the water regulation apparatus to the animal watering trough so that the housing cavity is in fluid communication with the animal watering trough. Further, in response to the fluid level in the animal watering trough moving below a predetermined threshold level, the method may comprise moving the fill valve from a first closed position, where the fluid is prevented from flowing between the intake port and the housing, into a second open position where fluid flows via the intake port into the housing. Additionally, the method may comprise transferring at least a portion of the fluid from the housing to the animal watering trough via the output port, and further, in response to the fluid level in the animal watering trough reaching at least the predetermined threshold level, the method may include moving the fill valve from the second position into the first position.

These and other embodiments may include additional innovative features.

### BRIEF DESCRIPTION OF THE DRAWINGS

Various embodiments of an apparatus, system, and method for a water regulation system are described below. In the course of this description, reference will be made to the accompanying drawings, which are not necessarily drawn to scale, and wherein:

FIG. 1 shows components of a water regulation apparatus;

FIG. 2A shows a top view of the water regulation apparatus of FIG. 1 with the removable cover of the water regulation apparatus removed;

FIG. 2B shows a side perspective view of the water regulation apparatus of FIG. 1;

FIG. 2C shows a bottom perspective view of the water regulation apparatus of FIG. 1;

FIG. 3 shows a side perspective view of the water regulation apparatus of FIG. 1 as a component of a water regulation system that includes a watering trough, according to one embodiment;

FIG. 4 shows a top view of the water regulation apparatus of FIG. 1 in an alternate embodiment of a water regulation system where the water regulation apparatus is integrally formed with the watering trough;

FIG. 5 shows a side perspective view of the water regulation system of FIG. 4.

### DETAILED DESCRIPTION

Various embodiments now will be described more fully hereinafter with reference to the accompanying drawings. It should be understood that the invention may be embodied in many different forms and should not be construed as limited to the embodiments set forth herein. Like numbers refer to like elements throughout.

This water regulation system enables a water holding tank (e.g., an animal watering trough) to be mechanically refilled with fluid, such as water, while also limiting the possibility of components or elements of the system breaking or malfunctioning, which can cause additional expenses based on wasting water (e.g., where the animal watering trough is overfilled) and replacing components.

### Preferred Embodiments

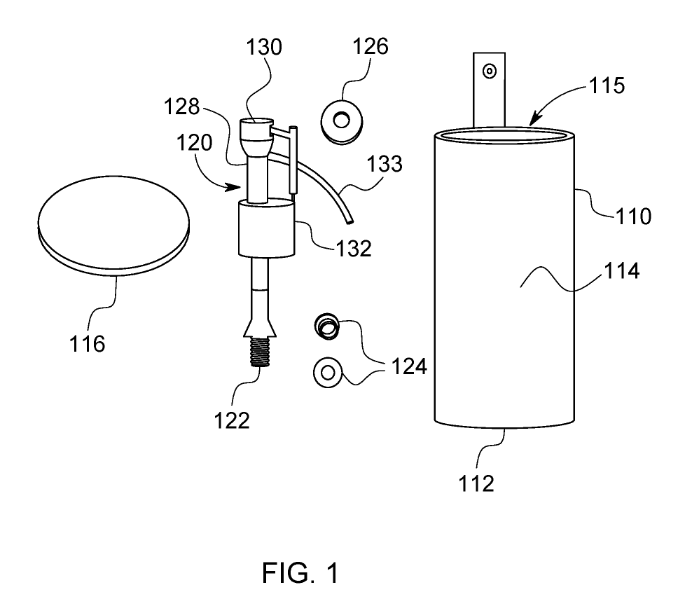

Referring to FIG. 1, a water regulation apparatus 100 is provided with the components of the water regulation apparatus 100 being shown in a preassembled fashion. The water regulation apparatus 100 comprises a housing 110, a fill valve 120 and a removable cover 116.

The housing 110 in various embodiments is substantially cylindrical in shape and includes a base 112 and one or more side walls 114. The housing 110 may be made of metal, plastic, a polymer, steel, stainless steel, aluminum, a combination thereof, or any material that will not be permeated by fluid. Additionally, the one or more side walls 114 of the housing 110 may be in the shape of a circle, oval, square, rectangle, or any polygonal shape. The housing 110 also includes a removable cover 116 that is configured to fit on the opposite side of the housing 110 from the base 112. The base 112 and removeable cover 116, in preferred embodiments, are substantially the same shape and are constructed of the same material as the side wall 114; however, such a configuration is not required. In preferred embodiments, the base 112 and removable cover 116 are circular, and are configured to meet the side wall 114 such that fluid (e.g., water) can be contained within a cavity 115 of the housing 110 defined by the base 112, side wall 114, and removeable cover 116 (although not required). The removable cover 116 prevents debris from entering the cavity 115 when the water regulation apparatus 100 is in use.

In preferred embodiments, the fill valve 120 is a Fluidmaster® fill valve, which may be Model 400, 400A, 400AH, 400LS, or any other type of suitable fill valve. In other embodiments, different types of valves may be used, which may include any type of float valve or slide valve. Still referring to FIG. 1, fill valve 120 includes a shaft 128 that extends from the fill valve base 122 to a top of the fill valve 120 where a valve plug 130 is located. The valve float 132 is slidably connected to shaft 128 and configured to slide up and down shaft 128. The valve float 132 is also connected to a valve plug 130 that is mounted to a top end of the shaft 128. The valve float is moveable between a first position that is closer to the valve plug 130 and a second position that is further away from the valve plug 130. When the valve float 132 is in the first position, the valve plug 130 is in a first closed position, and when the valve float 132 is in the second position, the vale plug is in a second opened position. As is well understood in the art, when the fill valve base 122 is connected to a fluid supply (e.g., a water faucet via a hose) and the valve plug is in the second open position, fluid may travel from the fluid supply through the fill valve plug 130 and out a fill valve output port 133. Additionally, when the fill valve plug 130 is in the first closed position, fluid is prevented from passing through the valve plug 130 and exiting the fill valve output port 133. The fill valve 120 further comprises a washer 126 that is formed of a material that provides a seal between the fill valve 120 and the housing 110 and a fastener 124 (e.g., for example the washer 126 may be formed from a polymer or a rubber material).

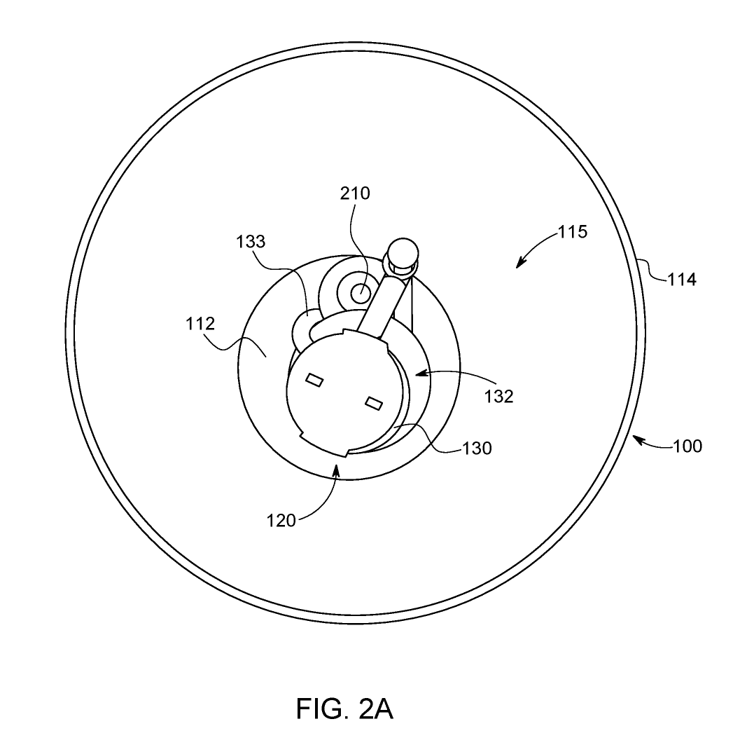

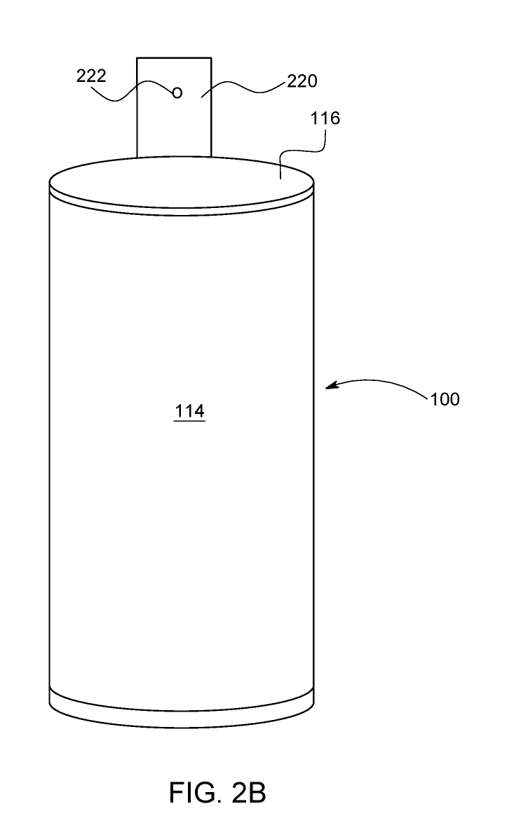

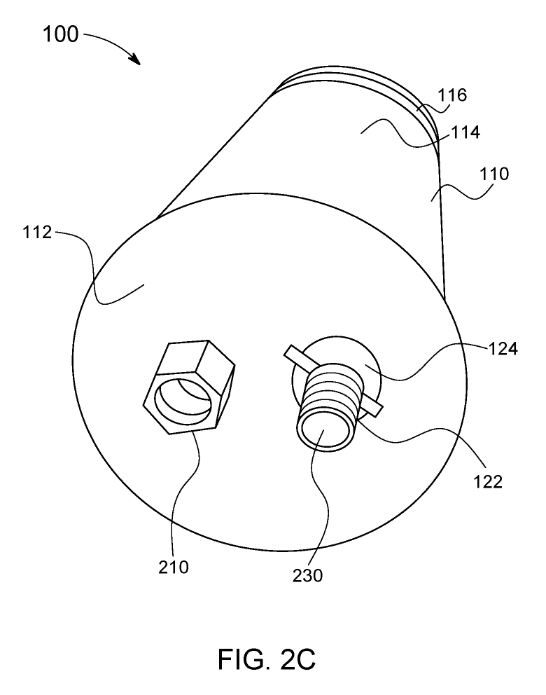

Referring to FIGS. 2A-2C, the fill valve 120 is configured to be secured within the cavity 115 of housing 110. Referring to FIG. 2A, a top view of the water regulation apparatus 100 is shown with the removable cover 116 removed to enable a view of the interior cavity 115 of housing 110. Fill valve 120 is mounted within the cavity 115 of housing 110 where the cavity 115 is formed by the housing side wall 114 and the housing base 112. FIG. 2B illustrates a side view of the water regulation apparatus 100. The water regulation apparatus 100 comprises housing 110 that includes base 112, side wall 114, and removable cover 116. Additionally, as seen in FIG. 2B, the water regulation apparatus 100 may include a mounting bracket 220 that may be configured to be connected to the housing 110 or it may be integrally formed therewith. Mounting bracket 220 may be made of a similar or different material as housing 110, and may be fastened to housing 110 by one or more screws, one or more bolts and nuts, an adhesive, welded, or any other fastening configuration. Mounting bracket 220 also includes a mounting aperture 222 to enable the mounting bracket to be fastened to an object (e.g., light pole, electric pole, fence, fence post, wall, etc.). A mounting location and mounting height of the water regulation apparatus 100 is further described below.

Finally, FIG. 2C illustrates a bottom perspective view of the water regulation apparatus 100. As shown in the figure, the housing base 112 has an input port 230 and an output port 210, which extend from the housing base 112. In various embodiments, the fill valve base 122 may be a component of input port 230. The input port 230 is configured to connect to a water source (e.g. a faucet, etc.) via a transfer hose or other conduit, and in preferred embodiments, the input port 230 is configured to connect to the transfer hose or conduit via a threaded connection.

Additionally, output port 210 is configured to connect to a remote location (e.g., an animal watering trough) via a transfer hose or conduit. In various embodiments, the output port 210 is configured to connect to a transfer hose or conduit via a threaded connection. Further, in various embodiments, the base 112 and/or side wall 114 may include one or more apertures to receive a heating element (not shown) that extends within the housing cavity 115 and may be used to heat fluid held within housing 110. In some embodiments, the input port 230 and/or output port 210 may be positioned at a different location of the housing 110 (e.g., through the side wall 114).

In preferred embodiments, the fill valve 120 is secured to the housing 110 by placing the fill valve base 122 through an opening formed in the housing base 112 (not shown in the Figures). The fill valve base 122 in the current implementation is threaded, and fastener 124 is used to secure the fill valve shaft 128 to the housing base 112 by threading the fastener 124 on to the fill valve base 122 on the exterior side of the housing base 112. Fastener 124 can be a nut; however, any type of fastener can be used to secure the fill valve base 122 to the housing base 112. Additionally, the washer 126 is placed on the shaft 128 on the interior side of the housing base 112 to enable a seal to be formed between the shaft 128 and the housing base 112 where the shaft passes through the housing base 112. It should be understood that the file valve 120 may be secured in the cavity via any other suitable method.

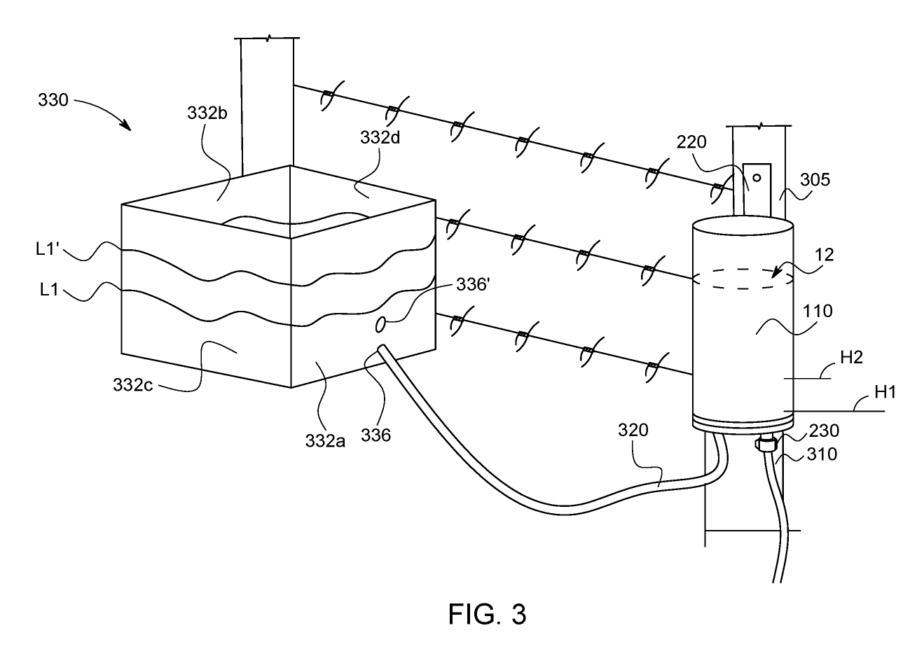

FIG. 3 shows a water regulation system 300 where the water regulation apparatus 100 is provided in an operational manner according to preferred embodiments. The water regulation apparatus 100 is mounted to a post 305 (e.g., a fence post) using the mounting bracket 220 via a bolt and nut connection; however, as previously described, the mounting bracket 220 may be attached to a number of different types of objects in a multitude of different fastening ways. A transfer hose 310 connects the fill valve 120 at input port 230 to a fluid supply (e.g., a faucet connected to a water line). A second transfer hose 320 connects the output port 210 (FIG. 2C) of the housing 110 to a fluid tank, which in preferred embodiments is an animal watering trough 330. Animal watering trough 330 is normally positioned in a location in which animals are able to access the animal watering trough 330 from multiple directions to drink water or other types of fluid provided to the animals. In various embodiments, the transfer hose 320 may be routed above ground to the animal watering trough 330 and in other embodiments some or most of the transfer hose 320 may be buried beneath the ground.

Animal watering trough 330 comprises one or more side walls 332a, 332b, 332c, and 332d, and a base 334, which may be flat or rounded. The one or more side walls 332a, 332b, 332c, and 332d and base 334 together define a cavity that holds water. The animal watering trough 330 may be made of metal, plastic, a polymer, steel, stainless steel, aluminum, a combination thereof, or any material that will not be permeated by fluid. Additionally, the one or more side wall 332a, 332b, 332c, and 332d may be in the shape of a circle, oval, square, rectangle, or any polygon shape. The transfer hose 320 connects to animal watering trough 330 via animal watering trough port 336, which is an aperture that may be positioned in base 334 and/or a side wall of the animal watering trough—shown in side wall 332a of the present implementation.

In the water regulation system 300, water is transferred from the water regulation apparatus 100 to the watering trough 330 based on pressure differentials at the output port 210 of the water regulation apparatus 100 and at the animal watering trough port 336. That is, when the water pressure at the animal watering trough port 336 is lower than the water pressure at the housing output port 210, water flows from the water regulation apparatus 100 into the animal watering trough 330. Various factors affect the water pressure such as the mounting height of the water regulation apparatus 100 relative to the animal watering trough 330, the position of the output port 210 with respect to the housing 110, the position of the animal watering trough input port 336 on the watering trough 330, among other things. Thus, when the pressures at the animal watering trough input port 336 and the housing output port 210 are equal, the water regulation system 200 is in equilibrium and fluid transfer between the water regulation apparatus 100 and the watering trough 330 does not occur.

Thus, when setting up the water regulation system 300, the user must determine a predetermined level that the water in the watering trough 330 is to be maintained by the water regulation apparatus 100. Said another way, the water regulation apparatus 100 regulates the water level in the watering trough 330 by opening and closing the fill valve 120 via movement of the valve float 132. Thus, when the watering trough water level is at a first predetermined threshold value L1 (i.e., a first watering trough water level) and the water level in the water regulation apparatus cavity 115 is at a second predetermined threshold level L2 (i.e., a first water regulation apparatus water level) the water regulation system 300 is at equilibrium. The first and second predetermined threshold values can be changed by adjusting the height of the water regulation apparatus 100 with respect to the animal watering trough 330. More particularly, the first and second predetermined threshold values can be changed by adjusting the height of the housing output port 210 with respect to the watering trough input port 336.

Moreover, when the first watering trough water level is at the first predetermined threshold value L1 and the first water regulation apparatus water level is at the second predetermined threshold level L2 (e.g., at equilibrium), the valve float 132 is maintained at a first position (i.e., a closed position) such that water will not flow from the water source into the housing cavity 115 via the fill valve 120 or from the housing cavity 115 into the watering trough 330. If on the other hand, fluid is removed from the watering trough 330 (e.g., the water is consumed by one or more animals) thereby causing the water level in the watering trough to drop below the first predetermined threshold value L1, then the water pressure at watering trough input port 336 drops below the water pressure at the housing output port 210 and water will flow from the housing cavity 115 into the watering trough 330 via the transfer hose 320.

As the water flows from the housing cavity 115 into the watering trough 330, the water level in the housing cavity 115 drops below the second predetermined threshold value L2 thereby causing the valve float 132 to move from the first position (i.e. the closed position) into a second position (i.e., an open position) in which water flows through the valve plug 130 and into the housing cavity 115 via the valve output port 133. In various embodiments, water can also flow in to the housing cavity 115 via the valve plug 130 when the valve float 132 in the second position. In this way, water will continue filling the housing cavity 115 to replace the water flowing from the housing cavity 115 into the watering trough 330 until the fluid level in the watering trough 330 rises to the first predetermined threshold value L1 and the fluid level in the housing cavity 115 rises to the second predetermined threshold value L2 thereby causing the valve float 132 to move from the second position (i.e., the open position) back into the first position (i.e., the closed position). In this state, the water regulation apparatus 100 and the watering trough 330 is in a state of equilibrium and water ceases to flow from the housing cavity 115 into the watering trough 330.

To further elaborate, in the current implementation, the water regulation system 300 uses a function of gravity to transfer water, via the transfer hose 320, from the cavity 115 of the water regulation apparatus 100 to the animal watering trough 330. For example, when output port 210 (FIG. 2C) is positioned at a first height, H1, and the animal watering trough port 336 is positioned at a height below output port 210, then the fluid in watering trough 330 will be maintained at the first predetermined threshold value L1 (e.g., when the water regulation system 300 is in equilibrium). However, if the height of the output port 210 is moved to a second height, H2, by moving the mounting location of the water regulation apparatus 100 higher on the post 305, or if the height of the input port 336 of the watering trough is lowered to a second position 336′, then the first predetermined threshold value of the water level in animal watering trough 330 will move from L1 to L1′ (i.e., a higher water level will be required in the watering trough 330 before the valve float moves from the second position into the first position).

In operation, the fluid, which can be water from a faucet connection, will travels from the faucet via the transfer hose 310 to the water regulation apparatus 100. The water enters through the input port 230, into the fill valve 120 (FIG. 1) and travels up the interior of the shaft 128 (FIG. 1) to where the fill valve plug 130 is located. When the valve float 132 is not in the first position (i.e. the closed position), the water exits the fill valve shaft 128 via the fill valve output port 133 and flows into the housing cavity 115. If the watering trough water level is below the first predetermined threshold value L1, the water will run from the housing cavity 115 to the watering trough 330 via the transfer hose 320. Once the watering trough water level reaches the first predetermined threshold value L1, the water flow from the housing cavity 115 ceases and the water level in the housing cavity 115 rises until it reaches the second predetermined threshold value L2. At this point, the valve float 132 moves from the second position (i.e., open position) into the first position (i.e., closed position) so that water flow through the fill valve 120 ceases. The valve float 132 moves from the second position into the first position by sliding up along the length of the shaft 128 as the water level rises in the housing cavity 115. It should be understood by one of skill in the art that the fill valve 120 may be adjustable to allow the user to adjust the level of the second predetermined threshold value L2 using one or more adjustment mechanisms. When the valve float 132 is in the first position, the valve plug 130 prevents water from being expelled from the fill valve output 133 in to the housing cavity 115.

Upon the water level in the animal watering trough 330 dissipating (e.g., by animals drinking the water, evaporation, etc.) below the first predetermined threshold value L1, water begins to transfer to the animal watering trough 330 from the housing cavity 115 via transfer hose 320. The cycle of filling repeats itself each time the water level in the watering trough drops a sufficient distance below the first predetermined threshold value L1 so that the pressure at the watering trough input port 336 drops below the pressure at the housing output port 210. The transfer of water is based on lower pressure occurring at the animal watering trough port 336 as compared to at the output port 210 of the water regulation apparatus 100, and the transfer of water will continue until the pressure at the animal watering trough port 336 is equalized with the pressure occurring at the output port 210 in the housing 110. At the point these two pressure levels are equalized, the transfer of water will stop.

### Alternate Embodiment

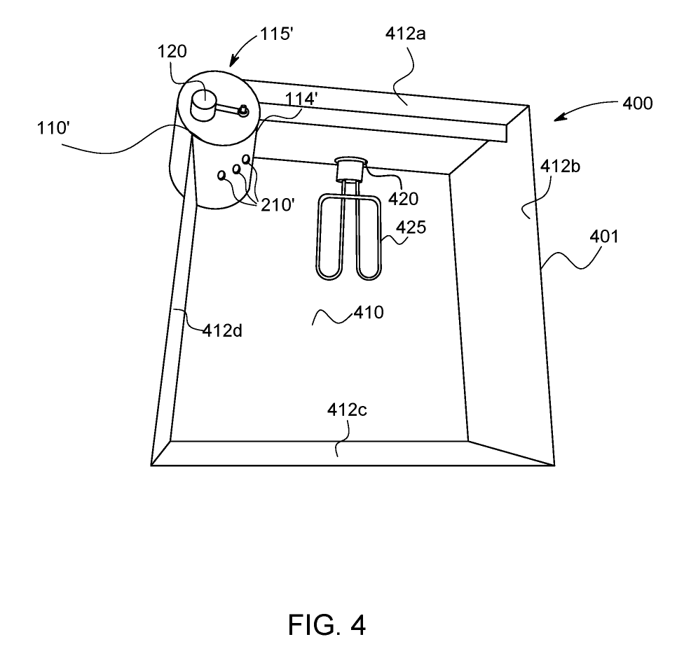

Referring to FIG. 4, an alternate embodiment of a water regulation system 400 is shown. The water regulation system 400 includes an alternative embodiment of a water regulation apparatus 100′ that is affixed to and part of animal watering trough 401. Animal watering trough 401 can be the same as or similar to animal watering trough 330 described above. Animal watering trough 401 is configured to hold the fluid within a cavity formed by a base 410, which may be flat or rounded, and one or more side walls 412a, 412b, 412c, and 412d. The animal watering trough 401 may be made of metal, plastic, a polymer, steel, aluminum, a combination thereof, or any material that will not be permeated by fluid. Additionally, the one or more side wall 412a, 412b, 412c, and 412d may be in the shape of a circle, oval, square, rectangle, or any polygon. In some embodiments, as shown in FIG. 4, one or more apertures 420 may be provided in base 410 and/or side walls 412a, 412b, 412c, and 412d. The one or more apertures 420 are configured to receive one or more heating elements 425 that extend within the cavity of the animal watering trough 401 and may be used to heat the fluid held within the animal watering trough 401 to prevent the fluid from freezing.

In preferred embodiments as shown in FIG. 4, the water regulation apparatus 100′ is fastened or affixed to one or more portions of the animal watering trough 401. The water regulation apparatus 100′ may be fastened or affixed to one or more side walls (412a, 412b, 412c, 412d) and base 410. In the present embodiment, the water regulation apparatus 100′ is positioned between and welded to side wall 412a and 412d. However, in other implementations, the water regulation apparatus 100′ may be fastened or affixed in a different manner, for example, soldered or brazed (depending on the material of the animal watering trough 401), adhesive, bolt and nut connection, screw connection, etc. Additionally, in other implementations, the water regulation apparatus 100′ may be fastened or affixed to a different part of the animal watering trough 401. In still other embodiments, the water regulation apparatus 100′ may be integrally formed with one or more sides of the watering trough 401.

The water regulation apparatus 100′ includes the same configuration and mechanisms as water regulation apparatus 100 shown in FIGS. 1-3; however, the location of the output port 210′ of water regulation apparatus 100′ differs from that of output port 210 described in FIGS. 1-3. Moreover, the water regulation apparatus 100′ may also include a removable cover 116, as previously described. In the preferred embodiments, there are three output ports 210′ (210′a, 210′b, and 210′c) provided in side wall 114′. However, such a configuration is not required, and more or fewer output ports 210′ may be provided. Additionally, the location of the output ports 210′ may vary along the length of the side wall 114′. In various embodiments, the output ports 210′ are positioned below the predetermined threshold value L2′ of the fluid in the cavity 115′ or at least below the predetermined threshold value L1′ of the fluid in the watering trough 401. As a result of the configuration of the water regulation system 400, the housing cavity 115′ is in fluid communication with the watering trough cavity via the output ports 210′.

The theory behind the operation of the water regulation system 400 operates differently than that of the water regulation system 300. In the water regulation system 400, the first predetermined threshold value L1′ and the second predetermined threshold value L2′ are equal since the two cavities are directly connected by the output ports 210′. That is, the housing cavity 115′ is an extension of the cavity formed by the watering trough 401 such that when the fluid level in the watering trough drops, the fluid level in the housing cavity 115′ also drops by the same amount such that the fluid levels in each cavity is the same. In some embodiments, if the water level in the watering trough drops faster than the water can flow through output ports 210′, then fluid level in the watering trough 401′ may initially be lower than the fluid level in the housing cavity 115′ since the rate of dissipation from the watering trough 401′ is faster than the transfer rate of fluid through output ports 210′. However, the fluid level in both cavities should equalize over time.

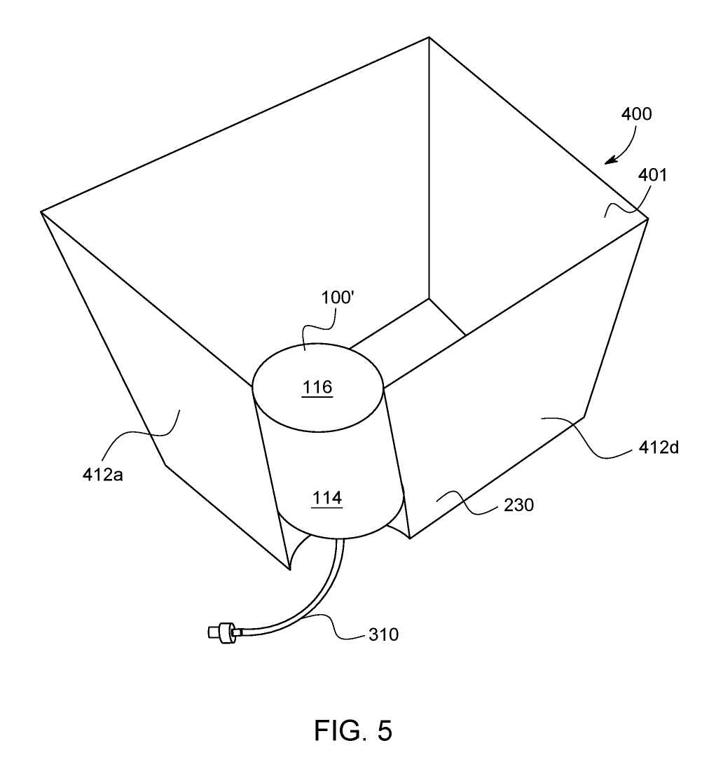

In operation, the fluid, which can be water from a faucet connection, travels from the faucet via a transfer hose (e.g., transfer hose 310 shown in FIG. 5) to the water regulation apparatus 100′. The water then reaches the input port 230 (shown in FIG. 5) and enters the fill valve 120 at the fill valve base 122 (FIG. 1). The water then travels up the interior of the shaft 128 to where the fill valve plug 130 is located. The valve float 132 adjusts to the water level in the housing 110′ and in the watering trough 401, and will be positioned to float at the top of the water level. As described in the first embodiments, so long as the water level in the housing cavity 115′ is at a second predetermined value L2, the valve float will be in the first position (i.e., the closed position) and fluid will not flow through the fill valve 120 into the housing cavity 115′. If the water level within the housing cavity 115′ drops below the second predetermined threshold value L2, the valve float 132 moves from the first position into the second position (i.e., the open position) thereby allowing fluid to flow through the valve plug 130 into the housing cavity 115′. As in prior embodiments, the second predetermined threshold value may be adjusted using various adjustment mechanisms on the fill valve 120. As the fill valve 120 expels water into the housing cavity 115′, the water level in the housing cavity 115′ increases—assuming water is not being transferred from the housing cavity 115′ via the output ports 210′. As the water level in the housing cavity 115′ increases, the valve float 132 also raises with the water level in the cavity. Once the valve float 132 reaches the second predetermined threshold value L2, the valve float 132 moved from the second position back into the first position thereby causing the valve plug 130 to move from the open position into the closed position. In the closed position, the valve plug 130 prevents water from being expelled from the fill valve 120 in to the housing cavity 115′.

When fluid in the watering trough cavity drops (e.g., due to animals drinking the fluid or by evaporation), fluid will automatically transfer from the housing cavity 115′ through the output ports 210′ into the watering trough 401 to maintain the fluid level in the watering trough at the first predetermined threshold value L2′. The valve float 132 will slide downward on the fill valve shaft 128 moving the valve float 132 from the first closed position into the second open position. In this configuration, fluid flows from the fluid source through the fill valve 120 into the housing cavity 115′. As the fluid flows into the housing cavity 115′, the fluid level in the housing cavity 115′ and the watering trough 401 begin to rise until the fluid level in watering trough 401 reaches the first predetermined threshold value L1′ and the fluid level in the housing cavity 115′ reaches the second predetermined threshold value L2′. Once the fluid levels respectively reach the first and second predetermined threshold values L1′ and L2′, the fluid flowing from the housing cavity 115′ stops transferring from the housing cavity 115′ to the animal watering trough 401 via the one or more output port 210′. At this point, the valve float 132 moves from the second open position into the first closed position so that fluid does not pass through the valve plug 130. In the closed position, valve plug 130 prevents water from being expelled from the fill valve 120 in to the housing cavity 115′.

The range of the water level in the animal watering trough 401 is dependent upon the height at which the valve float 132 moves from the second open position into the first closed position. Thus, the first and second predetermined threshold values L1′ and L2′ are dependent on the level of fluid that causes the valve float to move into the first closed position. It should be understood that the position of the valve float first position can be adjusted using one or more adjustment mechanisms that are part of the fill valve 120.

FIG. 5 illustrates a side perspective view of the water regulation system 400where the transfer hose 310 connects between a fluid supply (e.g., water faucet) and the input port 230, which is also shown at base 112 of the housing 110′. Additionally, the water regulation apparatus 100′ is shown with the removeable cover 116 secured to the top of the water regulation apparatus 100′ to prevent interference with the operation of the fill valve 120 and the interior of the housing 110—e.g., preventing mud, dirt or debris from getting in the housing 110′ and preventing animals around the animal watering trough 401 from damaging components of the fill valve 120.

### Conclusion

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different mechanical and operational configurations. For example, while several embodiments above include using a substantially square shaped animal watering trough, other embodiments may use an oval shaped animal watering trough, a rectangular shaped animal watering trough or a circular shaped animal watering trough. Moreover, while the water regulating apparatus is shown formed in a elongated cylindrical shape, the water regulating apparatus may be formed in any particular shape based on the application of the water regulating apparatus. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed:

1. A water regulation system for regulating a fluid level in an animal watering trough, comprising:
a housing having
at least one side wall,
a base, and
a removable cover,
wherein the at least one side wall, the base, and the removeable cover define a cavity that is configured to contain fluid;
a fill valve positioned within the cavity of the housing for controlling a level of the fluid within the housing;
an intake port configured to be connected to a fluid supply; and
an output port in fluid communication with an animal watering trough,
wherein
when the fill valve is in a first position, the fluid is prevented from flowing between the intake port and the housing, and
when the fill valve moves into a second position, the fluid flows via the intake port into the housing.

2. The water regulation system of claim 1, wherein
the housing is integral with the animal watering trough, and
the animal watering trough comprises one or more sidewalls.

3. The water regulation system of claim 2, wherein the output port comprises one or more bores that extends through the at least one side wall of the housing such that fluid within the housing is enabled to flow into the animal watering trough via the one or more bores.

4. The water regulation system of claim 1, wherein
a level of fluid in the cavity of the housing is substantially similar to a level of fluid in the animal watering trough, and
in response to the level of fluid in the cavity of the housing moving below a predetermined threshold level, the fill valve moving from the first position to the second position.

5. The water regulation system of claim 1, further comprising:
one or more heating elements that extends from at least one of (i) an exterior of a base or at least one of the one or more sidewalls of the animal watering trough through an interior of the base or of the at least one of the one or more sidewalls of the animal watering trough, and (ii) an exterior of the base or at least one of the at least one side wall of the housing through an interior of the base or the at least one of the at least one side wall of the housing.

6. The water regulation system of claim 1, wherein
the output port extends through one of the base or at least one side wall of the housing,
a first end of a transfer hose is coupled to the output port of the animal watering trough,
a second end of the transfer hose is connected to an animal watering trough input port,
the animal watering trough input port extends through a base or at least one side wall of the animal watering trough, and
the cavity of the housing is in fluid communication with the animal watering trough via the transfer hose.

7. The water regulation system of claim 6, wherein at least one of the output port and the animal watering trough input port is threaded such that the first end of the transfer hose or the second end of the transfer hose is coupled to the at least one of the output port and the animal watering trough input port via a threaded connection.

8. The water regulation system of claim 6, further comprising:
the housing being positioned at a height relative to the animal watering trough such that in response to fluid of the animal watering trough dissipating below a watering trough threshold fluid level, which is based in part on at least the height of the housing relative to the animal watering trough and the location of the animal watering trough input port, transferring fluid from within the cavity of the housing to the animal watering trough via the transfer hose.

9. The water regulation system of claim 8, further comprising:
in response to the fluid level of the animal watering trough increasing to the animal watering trough threshold fluid level, the transfer of fluid from the cavity of the housing to the animal watering trough via the transfer hose being suspended.

10. The water regulation system of claim 8, further comprising:
in response to the fluid in the cavity of the housing being below a housing threshold level, the fill valve moving from the first position to the second position, and
in response to the fluid in the cavity of the housing increasing to at least the housing threshold level, the fill valve moving from the second position to the first position.

11. The water regulation system of claim 6, further comprising:
one or more heating elements that extends from at least one of (i) an exterior of a base or at least one of the one or more sidewalls of the animal watering trough through an interior of the base or of the at least one of the one or more sidewalls of the animal watering trough, and (ii) an exterior of the base or at least one of the at least one side wall of the housing through an interior of the base or the at least one of the at least one side wall of the housing.

12. An animal watering trough water regulation apparatus, comprising:
an animal watering trough that is configured to contain fluid; and
a water regulation apparatus, comprising:
a housing having
at least one side wall,
a base, and
a removable cover,
wherein the at least one side wall, the base, and the removeable cover define a cavity that is configured to contain fluid;
a fill valve positioned within the cavity of the housing for controlling a level of the fluid within the housing,
an intake port configured to be connected to a fluid supply, and
an output port operatively coupled to the animal watering trough,
wherein
when the fill valve is in a first position, the fluid is prevented from flowing between the intake port and the housing, and
when the fill valve moves into the second position, the fluid flows via the intake port into the housing and from the cavity of the housing into the animal watering trough.

13. The water regulation apparatus of claim 12, wherein
the housing is integrally formed with the animal watering trough, and
the animal watering trough comprises one or more sidewalls.

14. The water regulation apparatus of claim 13, wherein the output port comprises one or more bores that extends through the at least one side wall of the housing such that fluid within the housing is enabled to flow into the animal watering trough via the one or more bores.

15. The water regulation apparatus of claim 12 wherein
the output port extends through one of the base or the at least one side wall of the housing,
a first end of a transfer hose is connected to the output port animal watering trough,
a second end of the transfer hose is connected to an animal watering trough input port,
the animal watering trough input port extends through a base or at least one side wall of the animal watering trough, and
the watering trough is in fluid communication with the housing cavity via the transfer hose.

16. The water regulation apparatus of claim 12, further comprising:
the housing being positioned at a height relative to the animal watering trough such that in response to fluid of the animal watering trough dissipating below a animal watering trough threshold fluid level, which is based in part on at least the height of the housing relative to the animal watering trough animal watering trough, transferring fluid from the cavity of the housing to the animal watering trough via the transfer hose via gravity.

17. A method for controlling a level of fluid in an animal watering trough by a water regulation apparatus, comprising:
providing a water regulation apparatus comprising
a housing having:
at least one side wall,
a base, and
a removable cover,
wherein the at least one side wall, the base, and the removeable cover define a cavity that is configured to contain fluid;
a fill valve positioned within the cavity of the housing for controlling a level of the fluid within the animal watering trough,
an intake port configured to be connected to a fluid supply, and
an output port;
positioning the housing with respect to an animal watering trough in order to set a fluid level to be maintained in the animal watering trough;
coupling the output port of the water regulation apparatus to the animal watering trough so that the housing cavity is in fluid communication with the animal watering trough;
in response to the fluid level in the animal watering trough moving below a predetermined threshold level, moving the fill valve from a first closed position, where the fluid is prevented from flowing between the intake port and the housing, into a second open position where fluid flows via the intake port into the housing;
transferring at least a portion of the fluid from the housing to the animal watering trough via the output port; and
in response to the fluid level in the animal watering trough reaching at least the predetermined threshold level, moving the fill valve from the second position into the first position.

18. The water regulation apparatus of claim 17, wherein
the output port extends through one of the base or at least one side wall of the housing,
a first end of a transfer hose is coupled to the output port animal watering trough,
a second end of the transfer hose is connected to an animal watering trough input port,
the animal watering trough input port extends through a base or at least one side wall of the animal watering trough, and
the cavity of the housing is in fluid communication with the animal watering trough via the transfer hose.

19. The water regulation apparatus of claim 17, further comprising:
the housing being positioned at a height relative to the animal watering trough such that in response to fluid of the animal watering trough dissipating below a watering trough threshold fluid level, which is based in part on at least the height of the housing relative to the animal watering trough and the location of the animal watering trough input port, transferring fluid from within the cavity of the housing to the animal watering trough via the transfer hose.

20. The water regulation system of claim 19, further comprising:
in response to the fluid level of the animal watering trough increasing to the animal watering trough threshold fluid level, the transfer of fluid from the cavity of the housing to the animal watering trough via the transfer hose being suspended.
